(19) United States
(12) Patent Application Publication
(10) Pub. No.: US 2019/0063602 A1
(43) Pub. Date: Feb. 28, 2019

(54) Control Method For Torque Vectoring Using A Ball-Type Continuously Variable Transmission

(71) Applicant: Dana Limited, Maumee, OH (US)

(72) Inventors: Jeffrey M. David, Leander, TX (US); T. Neil McLemore, Leander, TX (US); Gordon M. McIndoe, Leander, TX (US)

(21) Appl. No.: 16/111,371

(22) Filed: Aug. 24, 2018

Related U.S. Application Data
(60) Provisional application No. 62/550,119, filed on Aug. 25, 2017.

(51) Int. Cl. F16H 61/664; F16H 59/14; F16H 59/44; F16H 59/38; B60W 10/105

(52) U.S. Cl. CPC F16H 61/6647; F16H 59/14; B60K 6/543; F16H 59/38; B60W 10/105; F16H 59/44

(57) ABSTRACT

Provided herein is a vehicle including: an electric axle powertrain including: a continuously variable electric drivetrain comprising a motor/generator and a ball-type continuously variable planetary (CVP), a drive wheel axle operably coupled to the continuously variable electric drivetrain, and a first wheel and a second wheel coupled to the drive wheel axle; and a controller configured to control a CVP speed ratio and determine a request for torque vectoring, wherein the controller commands a change in the CVP speed ratio based on the request for torque vectoring,

### RELATED APPLICATION

This application claims priority to U.S. Provisional Application No. 62/550,119 filed on Aug. 25, 2017, which is hereby incorporated herein by reference in its entirety.

### BACKGROUND

Hybrid vehicles are enjoying increased popularity and acceptance due in large part to the cost of fuel and greenhouse carbon emission government regulations for internal combustion engine vehicles. Electric axles for electric and hybrid vehicles can have an electric machine/motor with an output shaft that runs parallel to the axle of the motor vehicle. In current electric axle designs for both consuming as well as storing electrical energy, the rotary shaft from a combination electric motor/generator is coupled by a gear train, such as a planetary gear set, to the wheel. As such, the rotary shaft for the electric motor/generator unit rotates in unison with the wheel based on the speed ratio of the gear train. Continuously variable transmissions (CVT) and transmissions that are substantially continuously variable are increasingly gaining acceptance in various applications. Therefore, application of CVTs to electric axle designs can expand the operating potential.

### SUMMARY

Provided herein is a vehicle including: an electric axle powertrain including: a continuously variable electric drivetrain including a motor/generator and a ball-type continuously variable planetary (CVP), a drive wheel axle operably coupled to the continuously variable electric drivetrain, and a first wheel and a second wheel coupled to the drive wheel axle; and a controller configured to control a CVP speed ratio and determine a request for torque vectoring, wherein the controller commands a change in the CVP speed ratio based on the request for torque vectoring.

In some embodiments, the request for torque vectoring comprises a right-hand wheel torque and a left-hand wheel torque to form a torque vector command.

In some embodiments, the controller is configured to control a CVP shift actuator, the CVP shift actuator configured to control the CVP speed ratio.

In some embodiments, the controller determines a commanded CVP shift actuator force based on the torque vector command.

Provided herein is a method for controlling an electric axle powertrain having a ball-type continuously variable planetary (CVP), a drive wheel axle operably coupled to the CVP, and a first wheel and a second wheel coupled to the drive wheel axle, the method including the steps of: receiving a plurality of data signals provided by sensors located on the electric axle powertrain, the plurality of data signals including: a CVP speed ratio, a vehicle yaw angle, a first wheel speed, and a second wheel speed; determining a required vectoring torque based on the first wheel speed and the second wheel speed; determining a shift force command to the CVP based on the required vectoring torque; and commanding the shift force command to adjust the CVP speed ratio.

In some embodiments, the method further includes the step of determining a torque vector error by comparing, the required torque vector to an estimated torque vector.

In some embodiments, the shift force command is further determined by the torque vector error.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the devices are utilized, and the accompanying drawings of which:

FIG. 1 is a side sectional view of a ball-type variator.

FIG. 2 is a plan view of a carrier member that used in the variator of FIG. 1.

FIG. 3 is an illustrative view of different tilt positions of the ball-type variator of FIG. 1.

FIG. 4 is a block diagram schematic of a vehicle control system that can be implemented in a vehicle having a torque vectoring electric axle powertrain,

FIG. 5 is a schematic diagram of a torque vectoring electric axle powertrain having a continuously variable electric drivetrain drivingly engaged to an axle, two clutches, and wheels of a vehicle.

FIG. 6 is a schematic diagram of a continuously variable electric drivetrain having a ball-type continuously variable planetary, a motor/generator, and a two selectable gear sets,

FIG. 7 is a free body diagram depicting forces during torque vectoring in a vehicle equipped with an electric axle powertrain.

FIG. 8 is a graph of an actuator shift force versus ball-tilt angle as a function of torque vector magnitude.

FIG. 9 is a flow chart for an enable control process implementable in the vehicle control system of FIG. 4,

FIG. 10 is a wheel speed synchronization process that is implementable in the vehicle control system of FIG. 4.

FIG. 11 is a torque vectoring control process that is implementable in the vehicle control system of FIG. 4.

### DETAILED DESCRIPTION OF THE PREFERRED EMBODIMENTS

An electronic controller or control system is described herein that enables electronic control over a variable ratio transmission having a continuously variable ratio portion, such as a Continuously Variable Transmission (CVT), Infinitely Variable Transmission (IVT), or variator. The electronic controller can be configured to receive input signals indicative of parameters associated with an engine coupled to the transmission. The parameters can include, but are not limited to, throttle position sensor values, accelerator pedal position sensor values, vehicle speed, gear selector position, user-selectable mode configurations, and the like, or some combination thereof. The electronic controller can receive one or more control inputs. The electronic controller can determine an active range and an active variator mode based on the input signals and control inputs. The electronic controller can control a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. patent application Ser. No. 15/572,288, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, is optionally configured to control any of several types of variable ratio transmissions.

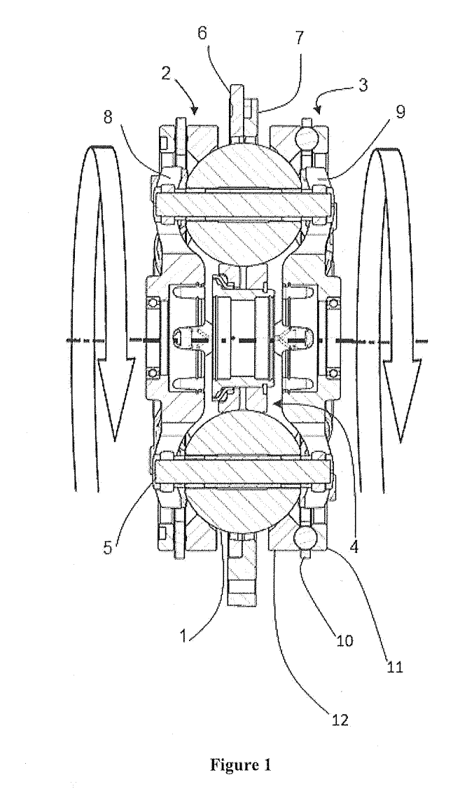

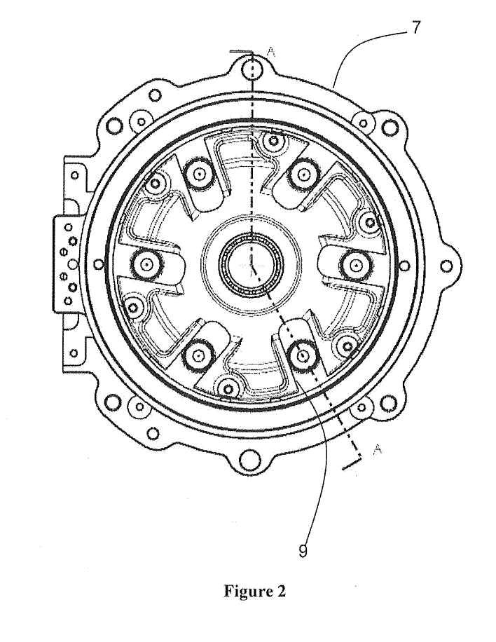

Provided herein are configurations of CVTs based on a ball-type variator, also known as CVP, for continuously variable planetary. Basic concepts of a ball-type Continuously Variable Transmissions are described in U.S. Pat. No. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input (first) traction ring assembly 2 and output (second) traction ring assembly 3, and an idler (sun) assembly 4 as shown on FIG. 1. In some embodiments, the output traction ring assembly 3 includes an axial force generator mechanism. The balls are mounted on tillable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members 6, 7 to impart a tilting of the axles 5 and thereby adjusts the speed ratio of the variator. Other types of ball CVTs also exist, like the one produced by Milner, but are slightly different.

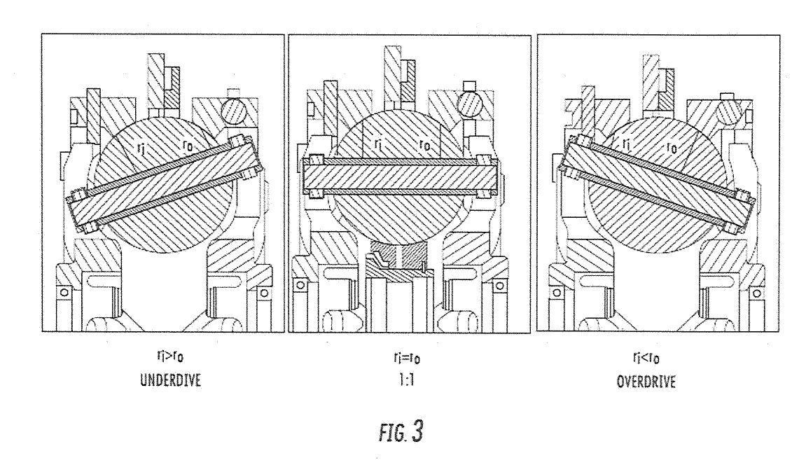

The working principle of such a CVP of FIG. 1 is shown on FIG. 3. The CVP itself works with a traction fluid. The lubricant or traction fluid between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted, the distance between the axis and the contact point change, modifying the overall ratio. All the balls' axes are tilted at the same time with a mechanism included in the carrier and/or idler, Embodiments disclosed herein are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”.

In some embodiments, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected”, “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element, It is noted that in using said terms to describe the embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial”, as used herein indicates a direction or position that is perpendicular relative to a longitudinal axis of a transmission or variator. The term “axial” as used herein refers to a direction or position along an axis that is parallel to a main or longitudinal axis of a transmission or variator.

it should be noted that reference herein to “traction” does not exclude applications where the dominant or exclusive mode of power transfer is through “friction”. Without attempting to establish a categorical difference between traction and friction drives herein, generally, these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces that would be available at the interfaces of the contacting components and is a measure of the maximum available drive torque. Typically, friction drives generally relate to transferring power between two elements by frictional forces between the elements. For the purposes of this disclosure, it should be understood that the CVTs described here could operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power'transfer direction, in such a case this component of creep is referred to as “transverse creep.”

Those of skill will recognize that the various illustrative logical blocks, modules, circuits, and algorithm steps described in connection with the embodiments disclosed herein, including with reference to the transmission control system described herein, for example, can be implemented as electronic hardware, software stored on a computer readable medium and executable by a processor, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system, Skilled artisans could implement the described functionality in varying ways for each particular application, but such implementation decisions should not be interpreted as causing a departure from the scope of the present embodiments.

For example, various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor could also be implemented as a combination of computing devices, e.g., a combination of a DSP and a microprocessor, a plurality of microprocessors, one or more microprocessors in conjunction with a DSP core, or any other such configuration. Software associated with such modules could reside in RAM memory, flash memory, ROM memory, EPROM memory, EEPROM memory, registers, a hard, disk, a removable disk, a CD-ROM, or any other suitable form of storage medium known in the art. An exemplary storage medium is coupled to the processor such the processor reads information from, and write information to, the storage medium. In the alternative, the storage medium can be integral to the processor. The processor and the storage medium could reside in an ASIC. For example, in one embodiment, a controller for use of control of the CVT includes a processor (not shown).

Provided herein is a vehicle control system for controlling a vehicle including a CVP and a moto-generator. The vehicle control system includes the electronic controller as described above.

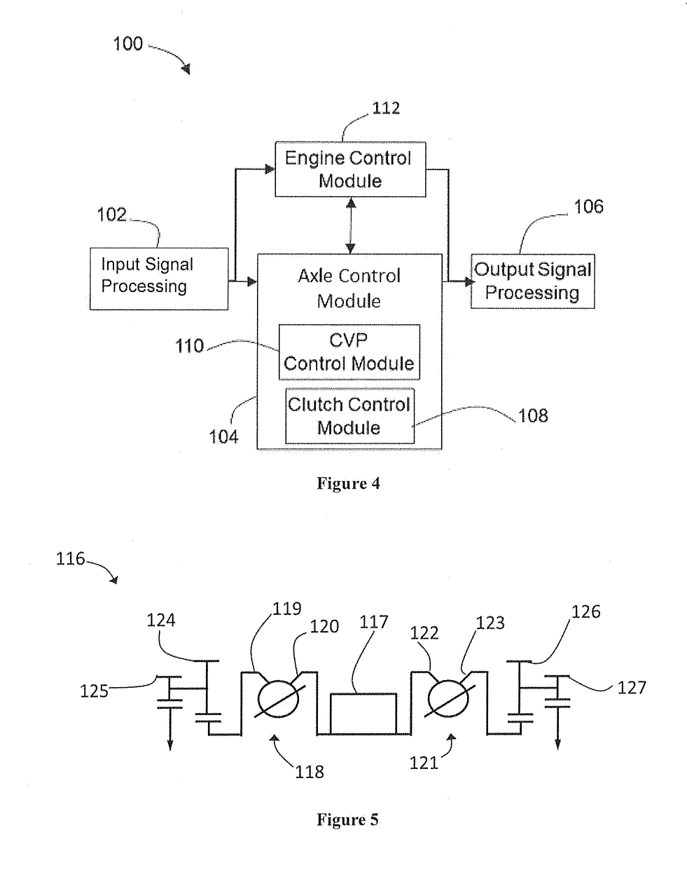

Referring now to FIG. 4, in some embodiments, a vehicle control system 100 includes an input signal processing module 102, an axle control module 104 and an output signal processing module 106. The input signal processing module 102 is configured to receive a number of electronic signals from sensors provided on the vehicle and/or transmission. The sensors can include, but are not limited to, temperature sensors, speed sensors, position sensors, among others.

In some embodiments, the signal processing module 102 includes various sub-modules to perform routines such as signal acquisition, signal arbitration, or other known methods for signal processing.

In some embodiments, the output signal processing module 106 is configured to electronically communicate to a variety of actuators and sensors.

In some embodiments, the output signal processing module 106 is configured to transmit commanded signals to actuators based on target values determined in the axle control module 104.

In some embodiments, the axle control module 104 includes a variety of sub-modules or sub-routines for controlling continuously variable transmissions of the type discussed here. For example, the axle control module 104 may include a clutch control sub-module 108 that is programmed to execute control over clutches or similar devices within the transmission.

In some embodiments, the clutch control sub-module 108 implements state machine control for the coordination of engagement of clutches or similar devices.

In some embodiments, the axle control module 104 includes a CVP control sub-module 110 programmed to execute a variety of measurements and determine target operating conditions of the CVP, for example, of the ball-type continuously variable transmissions discussed herein.

In some embodiments, the CVP control sub-module 110 incorporates a number of sub-modules for performing measurements and control of the CVP.

In some embodiments, the vehicle control system 100 includes an engine control module 112 configured to receive signals from the input signal processing module 102 and in communication with the output signal processing module 106. The engine control module 112 is configured to communicate with the axle control module 104.

In some embodiments, the vehicle control system 100 includes a number of other typical sub-modules such as a vehicle dynamics submodule and a stability control submodule adapted to monitor operation of the vehicle.

FIG. 5 depicts a torque vectoring continuously variable electric drivetrain (CVED) 116. In some embodiments, the CVED 116 is used with an electric axle powertrains disclosed herein. The CVED 116 includes a motor/generator 117, a first ball-type continuously variable planetary 118 having a first traction ring assembly 119 and a second traction ring assembly 120, and a second ball-type continuously variable planetary 121 having a third traction ring assembly 122 and a fourth traction ring assembly 123.

In some embodiments, the motor/generator 117 is operably coupled to the second traction ring assembly 120 and the third traction ring assembly 122. The CVED 116 is provided with a first gear set 124 operably coupled to the first traction ring assembly 119. The first gear set 124 is coupled to a second gear set 125. The second gear set 125 is configured to transmit power in and out of the CV ED 116. The CVED 116 includes a third gear set 126 operably coupled to the fourth traction ring assembly 123. The third gear set 126 is coupled to a fourth gear set 127. The fourth gear set 127 is configured to transmit power in or out of the CVED 116.

During, operation of the CVED 116, the first ball-type continuously variable planetary 118 and the second ball-type continuously variable planetary 121 are controlled independently to vary the torque transmitted to the second gear set 125 and fourth gear set 127 respectively. This modulation is sometimes referred to herein as “torque vectoring”. Torque vectoring is the intentional application of unequal wheel torques for the purposes of steering the vehicle in a controlled manner. Applications of torque vectoring include vehicle stability control, rear wheel steering, traction control, active safety systems, and autonomous vehicle control. Torque vectoring potentially enhances both vehicle cornering performance as well as vehicle safety.

Control methods disclosed herein are implementable on axles having a variator such as the one described in reference to FIGS. 1-3 and disclosed in Patent Cooperation Treaty Patent Application No. PCT/US17/049521 which is hereby incorporated by reference.

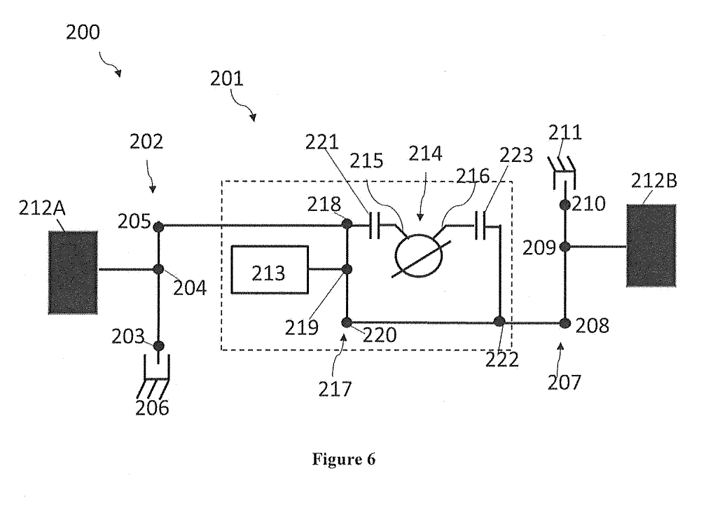

Referring now to FIG. 6, in some embodiments, a powertrain 200 is configured to include a CVED as described herein.

In some embodiments, the powertrain 200 includes a CVED 201 and a first planetary gear set 202 having a first ring gear 203, a first planet carrier 204, and a first sun gear 205. The first ring gear 203 is operably coupled to a first brake 206. The powertrain 200 includes a second planetary gear set 207 having a second ring gear 208, a second planet carrier 209, and a second sun gear 210. The second ring gear 208 is operably coupled to a second brake 211.

In some embodiments, the CVED 201 is operably coupled to the first sun gear 205 and the second sun gear 210. The first planet carrier 204 is operably coupled to the first wheel 212A. The second planet carrier 209 is operably coupled to the second wheel 212B.

It should be appreciated that the powertrains disclosed herein are configurable for torque vectoring where the speed ratio between the left and right wheels 212A, 21213 can, be controlled using the variator with the CVEDs disclosed herein.

In some embodiments, the continuously variable electric drivetrain (CVED) 201 includes a motor/generator 213 and a ball-type continuously variable planetary 214 having a first traction ring assembly 215 and a second traction ring assembly 216. The CVED 201 includes a planetary gear set 217 operably coupled to the first traction ring assembly 215. The planetary gear set 217 is provided with a ring gear 218, a planet carrier 219, and a sun gear 220.

In some embodiments, the ring, gear 218 is operably coupled to the first traction ring assembly 215. The planet carrier 219 is coupled to the motor/generator 213.

In some embodiments, the second traction ring 216 is operably coupled to the sun gear 220 at a combining node 222.

In some embodiments, a first clutch 221 is adapted to selectively couple the first traction ring assembly 215 to the ring gear 218.

In some embodiments, a second clutch 223 is adapted to selectively couple the second traction, ring assembly 216 to the combining node 222.

In some embodiments, rotational power is transmitted in and out of the CVED 201 through the ring gear 218 and the combining node 222.

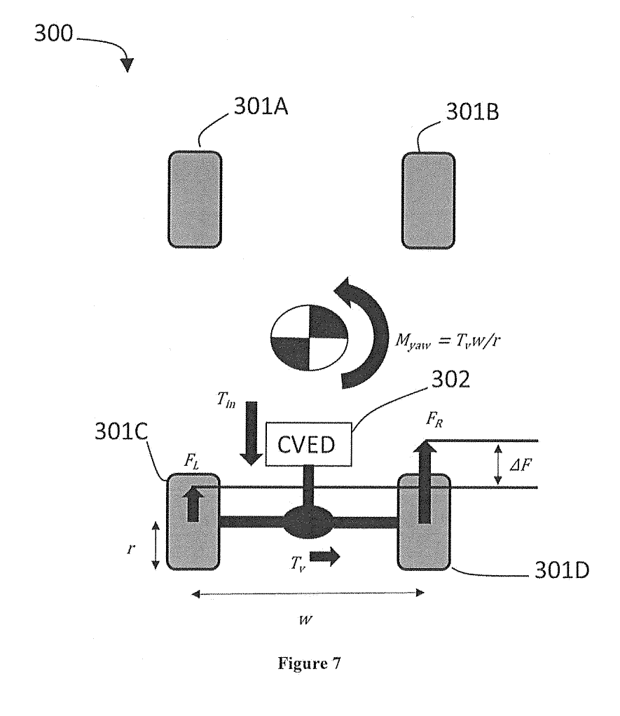

Referring now to FIG. 7, in some embodiments, a vehicle 300 includes a number of wheels 301A-301D receiving a rotational power from an axle including a CVED 302.

It should be appreciated that the free body diagram of FIG. 7 depicts a rear wheel driven vehicle and the following discussion in reference to the free body diagram is applicable to a front wheel driven vehicle. The default operating case for a vehicle in normal driving conditions having an input torque (Tᵢₙ) provides equal wheel torques where the left side torque (T_{left}) equals the right side torque (T_{right}) as follows:

$${T}_{left} = {T}_{right} = \frac{{T}_{in}}{2}$$

When torque vectoring is desired an intentional imbalance is created with a vectoring torque (Tᵥ), sometimes referred to herein as “vector torque”, and results in the following wheel torques:

$${T}_{left} = \frac{{T}_{in}}{2} - {T}_{v} and {T}_{right} = \frac{{T}_{in}}{2} + {T}_{v}$$

The resulting force difference (ΔF) delivered to the road is:

$$Δ F = \frac{2 * {T}_{v}}{r}$$

Where r=tire radius.
The resulting yaw moment (M_{yaw}) is as follows:

$${M}_{yaw} = ( \frac{{T}_{v}}{r} ) * ( \frac{w}{2} ) - ( \frac{- {T}_{v}}{r} ) * ( \frac{w}{2} ) = \frac{{T}_{v} * w}{r}$$

Where w=vehicle track width.
A yaw moment (M_{yaw}) in the opposite direction is achieved by inverting the sign of the left and right vector torque (Tᵥ) components.

$${M}_{yaw} = ( \frac{- {T}_{v}}{r} ) * ( \frac{w}{2} ) - ( \frac{{T}_{v}}{r} ) * ( \frac{w}{2} ) = \frac{- {T}_{v} * w}{r}$$

For axles equipped with a ball-type variator such as the one depicted in FIGS. 1-3, an actuator shift force on the first carrier member 6 or the second carrier member 7 provides the necessary actuator force change to produce the required torque vector moment. An illustrative example of an actuator shift force model is provided in U.S. patent application Ser. No. 15/939,526 which is hereby incorporated by reference. From the actuator shift force model, the shift force applied to the variator (ΔF_{carrier}_{_}ₒᵤₜ) is as follows.

$$Δ {F}_{carrier \_ out} = \frac{- ( {F}_{traction \_ in} * a + Δ {F}_{traction \_ out} * b )}{y}$$

where ΔF_{traction}_{_}ₒᵤₜ is proportional to the required torque vector, Tᵥ, through the relationships below,

$$Δ {F}_{traction \_ out} = \frac{{T}_{v}}{{r}_{traction}}$$

$${r}_{traction} = traction radius = {r}_{s} + {r}_{p} + {r}_{p} * cos ( {α}_{1} )$$

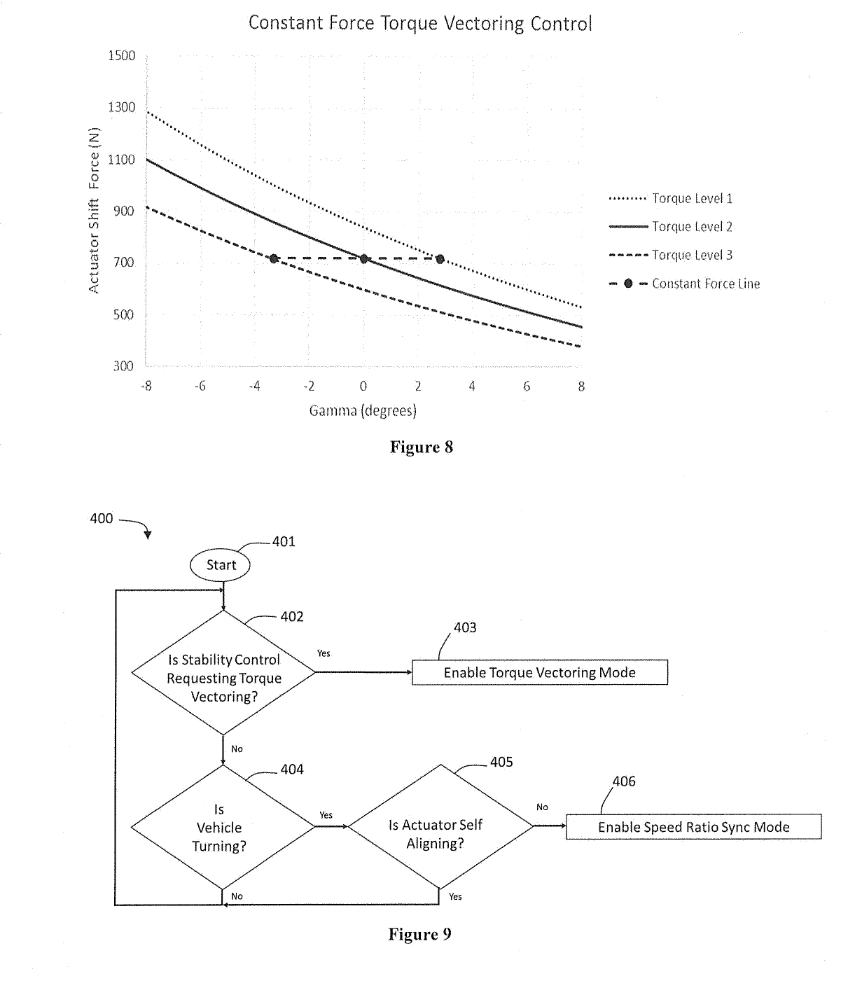

Referring now to FIG. 8, conversion from shift carrier force to actuator force is based on effective carrier radius as the tilt angle of the balls 1 change, the static shift carrier radius, and any sector gear ratio, for example such as those disclosed in U.S. patent application Ser. No. 15/939,526, which is hereby incorporated by reference. FIG. 8 depicts a plot where the initial conditions are assumed to include an input torque and speed from the motor, a constant actuator force, and equal wheel speeds during straight ahead driving.

The control system 100 is constrained in the speed domain and, therefore, as the vehicle 300 corners, the CVP speed ratio(s) changes. The inner wheel of the axle slows down and the speed ratio of the CVP moves towards an underdrive condition. The outer wheel of the axle speeds up and the speed ratio of the CVP moves towards an overdrive condition. The line labeled “Torque level 2” corresponds to an equal split of the CVED input torque, whereas the lines labeled “torque level 1” and “torque level 3” represent higher and lower torque value respectively. As the individual speeds of the inner wheel and the outer wheel change during turning or cornering, the vehicle control system 100 as described herein will force the inner and outer wheel torques to follow the iso-torque lines, with lower torque applied to the inner wheel, resulting in an applied torque vector moment in the direction of the turn. Provided that the shift force curve is as depicted in FIG. 8, where shift force is higher at underdrive ratios, the CVP passively provides the correct torque vector moment for left or right turns. The curves in FIG. 8 are the required actuator shift force as a function of ball tilt angle, or “gamma”, and input torque levels,

Turning now to FIG. 9, in some embodiments, an enable control process 400 is implemented in the vehicle control system 100. The enable control process 400 begins at a start state 401 and proceeds to a first evaluation block 402 where signals are evaluated to identify a request for torque vectoring.

In some embodiments, the vehicle control system 100 includes modules and algorithms associated with vehicle stability control that are configured to request torque vector from the axle. When the first evaluation block 402 returns a true result, indicating that there, is a torque vectoring request, the enable control process 400 proceeds to a block 403 where a command is sent to enable torque vectoring mode of operation. When the first evaluation block 402 returns a false result, indicating that there is no torque vectoring request, the enable control process 400 proceeds to a second evaluation block 404 where signals are evaluated to determine if the vehicle is turning. When the second evaluation block 404 returns a false result, indicating that the vehicle is not turning, the enable control process 400 proceeds to the start state 401. When the second evaluation block 404 returns a true result, indicating that the vehicle is turning, the enable control process 400 proceeds to a third evaluation block 405. The third evaluation block 405 evaluates self-alignment capabilities of a shift actuator for the axle system, for example, a shift actuator coupled to the CUED 201. When the third evaluation block 405 returns a true result, indicating that the shift actuator is self-aligning, the enable control process 400 returns to the start state 401. When the third evaluation block 405 returns a false result, indicating that the shift actuator is not self-aligning, the enable control process 400 proceeds to a block 406 where a command is sent to enable speed ratio synchronization mode.

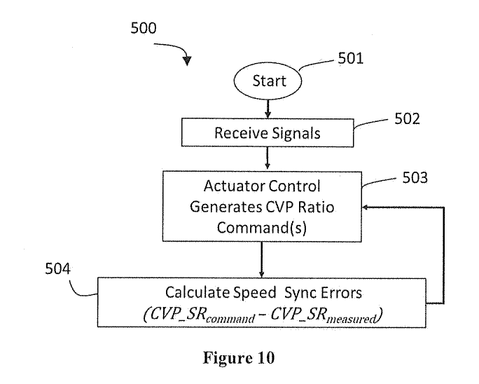

Referring now to FIG. 10, in some embodiments, the CVP shift actuation mechanisms equipped on the variator or variators of the CVD 302 are self-aligning and back drivable. These mechanisms automatically allow the CVP ratio(s) to find an equilibrium point in response to speed constrained ratio change during turns, and are collectively referred to a passive torque vectoring systems.

The shift actuator(s) is(are) optionally a hydraulic actuation system or a direct drive electric motor without any significant gear ratio between the motor and moveable shift carrier member of the CVP. Other CVP actuation mechanisms, for example, an electric motor with, a high ratio gear train between the motor and the moveable shift carrier member of the CVP, are non-back drivable and will not self-align. When not using a self-aligning actuation system it is necessary to track wheel speeds to provide differential action through CVP ratio control.

In some embodiments, the vehicle control system 100 is adapted to monitor motor input speed (Nᵢₙ), left and right wheel speeds (N_{L} and N_{R}), and generate the necessary CVP speed ratio commands to prevent the system from binding, The, control system 100 is constrained in the speed domain by wheel speeds and, therefore, the CVP speed ratio must follow along to prevent an unintended torque vector moment from being created during turning, For steady state driving without wheel slip the following relationship applies:

$${CVP\_SR}_{Left} = \frac{{N}_{L} * {GR}_{1} * {GR}_{2}}{{N}_{in}} and$$

$${CVP\_SR}_{Right} = \frac{{N}_{R} * {GR}_{3} * {GR}_{4}}{{N}_{in}}$$

Where GR₁, GR₂, etc. refer to gear passes, for example 202, 207, 217 that may be present between the CVP 214 and the wheels 212A, 212B as in the torque vectoring electric axle powertrain 200. for example. These gear passes may be transfer gears, planetary gears, or similar.

Referring stilt to FIG. 10, in some embodiments, a wheel speed synchronization process 500, sometimes referred to herein as “synchronization process” is implemented in the vehicle control system 100. The synchronization process 500 begins at a start state 501 and proceeds to a block 502 where a number of signals are received, such as motor speed and wheel speeds. The synchronization process 500 proceeds to a block 503 where a CVP ratio command is determined.

In some embodiments, the CVED 116 includes two CVPs, and the block 503 is configured to generate two CVP ratio commands, respectively. The synchronization process 500 proceeds to a block 504 where a speed synchronization error is determined by comparing the actual CVP speed ratio to the commanded CVP speed ratio. The synchronization process 500 returns to the block 503.

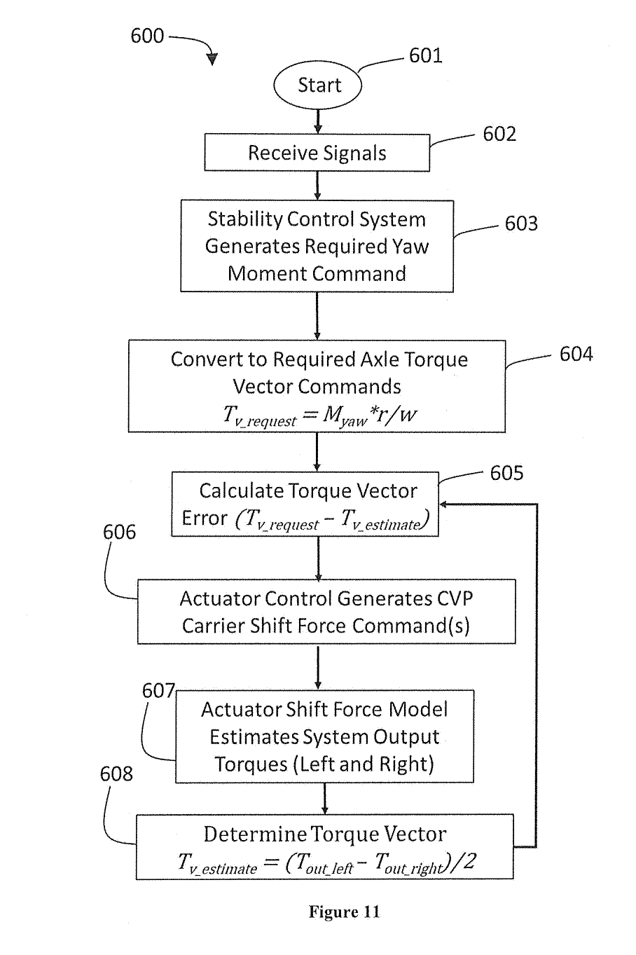

Turning now to FIG. 11, in some embodiments, passive torque vectoring with constant force control is not sufficient, an additional moment is provided by varying the CVP shift actuator force during operation of the torque vectoring electric axle powertrain 200.

In some embodiments, the required yaw moment is received from the stability control submodule provided in the vehicle control system 100. The required yaw moment is converted to a required vectoring torque. The CVP shift force actuator is commanded to generate the required torque vector. Shift actuator feedback is received from a pressure sensor if hydraulic, or motor current sensor if electric. Input torque to the CVP, and in some cases multiple CVPs, is known from the CVED motor commands and, therefore, a shift force model is used to estimate the output ring torque in each CVP.

Still referring to FIG. 11, in some embodiments, an active torque vectoring control process 600 is implemented in the vehicle control system 100. The torque vectoring control process 600 begins at a start state 601 and proceeds to a block 602 where a number of signals are received such as a vehicle yaw angle, a steering wheel angle, and wheel speeds. The torque vectoring control process 600 proceeds to a block 603 where a required yaw moment command is determined.

In some embodiments, the required yaw moment command is determined by a stability control submodule equipped in the vehicle control system 100.

The torque vectoring control process 600 proceeds to a block 604 where the required yaw moment command is converted to a required axle torque vector command. The torque vectoring control process 600 proceeds to a block 605 where a torque vector error is determined by comparing the required to torque vector to an estimated torque vector. The torque vectoring control process 600 proceeds to a block 606 where a CVP carrier shift force command is determined based on the torque vector error.

In some embodiments, the block 606 implements a P-I-D type of control algorithm to determine the CVP carrier shift force command based on the torque vector error.

In some embodiments, the CVP shift force command is determined by the CVP control sub-module 110. The torque vectoring control process 600 proceeds to a block 607 where estimates of output torque on right-hand and left-hand sides are determined using previously described methods. The torque vectoring control process 600 proceeds to a block 608 where the estimated torque vector is determined. The torque vectoring control process 600 returns to the block 605.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the preferred embodiments described herein can be employed in practicing the preferred embodiments. It is intended that the following claims define the scope of the preferred embodiments and that methods and structures within the scope of these claims and their equivalents be covered thereby.

What is claimed is:

1. A vehicle comprising;
an electric axle powertrain comprising:
a continuously variable electric drivetrain comprising a motor/generator and a ball-type continuously variable planetary (CVP);
a drive wheel axle operably coupled to the continuously variable electric drivetrain; and
a first wheel and a second wheel coupled to the drive wheel axle; and
a controller configured to control a GYP speed ratio and determine a request for torque vectoring,
wherein the controller commands a change in the GYP speed ratio based on the request for torque vectoring.

2. The vehicle of claim 1, wherein the request for torque vectoring comprises a right-hand wheel torque and a left-hand wheel torque to form a torque vector command.

3. The vehicle of claim 2, wherein the controller is configured to control a CVP shift actuator, the GYP shift actuator configured to control the CVP speed ratio.

4. The vehicle of claim 3, wherein the controller determines a commanded CVP shift actuator force based on the torque vector command.

5. A method for controlling, an electric axle powertrain having a ball-type continuously variable planetary (CVP), a drive wheel axle operably coupled to the CVP, and a first wheel and a second wheel coupled to the drive wheel axle, the method comprising the steps of:
receiving a plurality of data signals provided by sensors located on the electric axle powertrain, the plurality of data signals comprising:
a CVP speed ratio,
a vehicle yaw angle,
a first wheel speed, and
a second wheel speed;
determining a required vectoring torque based on the first wheel speed and the second wheel speed;
determining a shift force command to the CVP based on the required vectoring torque; and
commanding the shift force command to adjust the CVP speed ratio.

6. The method of claim 5, further comprising the step of determining a torque vector error by comparing the required torque vector to an estimated torque vector.

7. The method of claim 6, wherein the shift force command is further determined by the torque vector error.
